(19) United States
(12) Patent Application Publication
(10) Pub. No.: US 2004/0131861 A1
(43) Pub. Date: Jul. 8, 2004

(54) Device and method for forming alignment layer of liquid crystal display device

(76) Inventors: Kyung Su Chae, Taegu-kwangyokshi (KR); Young Sang Byun, Kyongsangbuk-do (KR); Heon Do Yun, Taegu-kwangyokshi (KR)

Correspondence Address: BIRCH STEWART KOLASCH & BIRCH, PO BOX 747, FALLS CHURCH, VA, 22040-0747, US

(21) Appl. No.: 10/687,776

(22) Filed: Oct. 20, 2003

(30) Foreign Application Priority Data
Dec. 11, 2002 (KR) P2002-78814

(51) Int. Cl. B32B 9/04

(52) U.S. Cl. 428/411.1

(57) ABSTRACT

A device and method for forming an alignment layer of an LCD device are provided. In the device, a drying part is positioned vertically above a printing part, and an alignment layer is deposited on a substrate according to an inkjet method, so that it is possible to form the alignment layer on the substrate without relation to the size of the substrate. This improves the efficiency in using a clean room.

This application claims the priority benefit of the Korean Patent Application No. P2002-78814 filed on Dec. 11, 2002, which is hereby incorporated by reference.

### BACKGROUND OF THE INVENTION

1. Field of the Invention

The present invention relates to a liquid crystal display (LCD) device, and more particularly, to a device and method for forming alignment layers on the lower and upper substrates of an LCD device.

2. Discussion of the Related Art

With development of information society, demands for various display devices have increased. Accordingly, efforts have been made to research and develop various flat display devices such as liquid crystal display (LCD), plasma display panel (PDP), electroluminescent display (ELD), and vacuum fluorescent display (VFD). Some species of the flat display devices are already applied to displays of various equipment.

Among the various flat display devices, the LCD device has been most widely used due to the advantageous characteristics of thinness, lightness in weight, and low power consumption, whereby the LCD device is often substituted for Cathode Ray Tube (CRT). In addition to the mobile type LCD devices such as a display for a notebook computer, the LCD devices have been developed for computer monitors and televisions to receive and display broadcasting signals.

A general LCD device includes an LCD panel for displaying a picture image, and a driving part for applying a driving signal to the LCD panel. Also, the LCD panel includes first and second glass substrates bonded to each other at a predetermined interval, and a liquid crystal layer between the first and second substrates. At this time, the first substrate (TFT array substrate) is comprised of a plurality of gate lines arranged in one direction at fixed intervals, a plurality of data lines arranged at fixed intervals for being in perpendicular to the plurality of gate lines, a plurality of pixel electrodes arranged as the matrix type in respective pixel regions defined by the plurality of gate and data lines crossing each other, and a plurality of thin film transistors being switched according to signals of the gate lines for transmitting signals of the data lines to the respective pixel electrodes. The second substrate (color filter array substrate) includes a black matrix layer excluding light from portions of the first substrate except the pixel regions, a R/G/B color filter layer for displaying various colors, and a common electrode for displaying the picture image.

A predetermined space is maintained between the first and second substrates by spacers, and the first and second substrates are bonded to each other by a sealant having a liquid crystal injection inlet. At this time, the liquid crystal layer is formed according to a liquid crystal injection method, in which the liquid crystal injection inlet is dipped into a container having liquid crystal while maintaining a vacuum state in the predetermined space between the first and second substrates. That is, the liquid crystal is injected between the first and second substrates by an osmotic action. Then, the liquid crystal injection inlet is sealed with the sealant.

The LCD device is driven according to optical anisotropy and polarizability of liquid crystal. Herein, liquid crystal molecules are aligned with directional characteristics in that the liquid crystal molecules respectively have long and thin shapes. In this respect, an electric field is applied to the liquid crystal for controlling the alignment direction of the liquid crystal molecules. That is, if the alignment direction of the liquid crystal molecules is controlled by the electric field, the light is refracted to the alignment direction of the liquid crystal molecules according to the optical anisotropy of the liquid crystal, thereby displaying the picture image.

As mentioned above, in order to align the liquid crystal molecules of the liquid crystal layer between the first and second substrates, it is required to form alignment layers on the first substrate having a thin film transistor array, and on the second substrate having a color filter array. The alignment layer is classified into an organic alignment layer and an inorganic alignment layer. Generally, the organic alignment layer is formed of polyimide. Here, an organic high-polymer layer is formed on the substrate according to a rotative deposition method or a print deposition method, and a hardening and rubbing process is performed thereto, thereby forming the alignment layer. The rubbing process is performed to define an alignment direction of the liquid crystal molecules by defining an alignment angle on a surface of the alignment layer.

Hereinafter, a method for forming the alignment layer on the first or second substrate of the LCD device will be described with reference to the accompanying drawings.

FIG. 1 is a flow chart illustrating a method for forming a general alignment layer. Referring to FIG. 1, the method for forming the general alignment layer includes three steps: the first step ST1 for forming an alignment layer by depositing an alignment material on a first substrate or a second substrate; the second step ST2 for hardening the alignment layer at a predetermined temperature to obtain the desired hardness of the alignment layer; and the third step ST3 for rubbing a surface of the hardened alignment layer to form minute grooves.

FIG. 2 is a schematic view illustrating a device for printing an alignment layer of an LCD device according to the related art. Referring to FIG. 2, the device for printing the alignment layer of the LCD device according to the related art includes a doctor roll 11, an anilox roll 13, a printing roll 15, and a rubber plate 17. In the device for printing the alignment layer having the plurality of rolls engaged with one another, an alignment layer is printed on a substrate 10. Among the plurality of rolls, the doctor roll 11 is operated to engage with the anilox roll 13, and the printing roll 15 is operated to engage with the anilox roll 13. Minute grooves 13a are formed on the rolling side of the anilox roll 13. Also, the rubber plate 17 having a plurality of predetermined patterns adheres to one side of the printing roll 15. The predetermined patterns of the rubber plate 17 are emboss patterns, which are for printing the alignment layer on the substrate except portions for depositing a sealant, and for forming a pad of a thin film transistor array substrate.

A method for forming the alignment layer on the substrate with the aforementioned printing device will be described as follows by referring to FIGS. 1 and 2.

First, a substrate 10 for printing an alignment layer thereon is fixed to a predetermined fixing device 12. Then, an alignment material is sprayed onto the anilox roll 13. When operating the device for printing the alignment layer having the plurality of rolls, the doctor roll 11 is operated to engage with the anilox roll 13, so that the alignment material sprayed onto the anilox roll 13 is deposited on the minute grooves 13a of the anilox roll 13. Subsequently, the alignment material deposited on the anilox roll 13 is printed on the rubber plate 17 of the printing roll 15 as the anilox roll 13 and the printing roll 15 rotate as engaged with each other. As the printing roll 15 rolls, the alignment material printed on the rubber plate 17 is transferred and printed on the substrate 10 according to the emboss pattern of the rubber plate 17, thereby forming the alignment layer 21 on the substrate 10 (ST1). After that, the alignment layer 21 on the substrate 10 is hardened at a predetermined temperature (ST2), and then the rubbing process is performed on the hardened alignment layer 21 with a rubbing roll 23 (ST3). According to the aforementioned method, the alignment layer is formed on the substrate 10.

However, in the method for forming the alignment layer with the related art device, it is necessary to perform the process for adhering the rubber plate 17 to the printing roll 15, and to clean the respective rolls. If the respective rolls are not clean, the substrate coated with the alignment layer may have spots or pinholes in the hardening process due to contamination. Also, since the minute grooves 13a are formed on the anilox roll 13, the anilox roll 13 is easily worn out as the anilox roll 13 engages with the doctor roll 11. That is, after some use, the minute grooves 13a of the anilox roll 13 change in shapes, and the doctor roll 11 wears out, so that it is necessary to periodically change the anilox roll 13 and the doctor roll 11 in the device for forming the alignment layer according to the related art. Accordingly, work efficiency is lowered in that printing of the alignment layer on the substrate cannot be made during the changing of the anilox roll 13 and the doctor roll 11. This increases the manufacturing cost and price. Further, the rubber plate 17 has less hardness and shorter lifetime as compared with the other components of the related art device, such that it also needs to be replaced frequently. Moreover, with a variety of glass substrates having different sizes, it is required to change a pattern of an array substrate and thus the pattern of the rubber plate 17 according to a model, thereby further lowering the work efficiency.

FIG. 3 is a plan view illustrating the inside of a clean room having a device for forming an alignment layer according to a roller method. Referring to FIG. 3, the clean room includes a first transferring part 6, a printing part 3, a second transferring part 7, a drying part 4, and a third transferring part 8. The printing part 3 includes two rows for simultaneously printing respective alignment layers on two substrates.

More specifically, the printing part 3 receives the substrate 10 from a proceeding process by the first transferring part 6 to print the alignment layer thereon. After completing the printing process of the alignment layer on the substrate 10, the second transferring part 7 transfers the substrate 10 to the drying part 4 for drying the alignment layer printed on the substrate 10, and then the substrate 10 is transferred by the third transferring part 8 for a baking process and a rubbing process. Accordingly, the process for forming the alignment layer is complicated, and it is hard to obtain the unification of the printing part 3 and the drying part 4 since the height of the rollers in these parts is at 2.5 m to 3 m. Further, recently, with the trend of producing the large-sized glass substrate for the LCD device, the array substrate size of the printing roll 15 may be smaller than the required size of the substrate 10. This generates the inconvenience of having to perform the alignment layer printing process several times to cover the large-sized substrate 10.

### SUMMARY OF THE INVENTION

Accordingly, the present invention is directed to a device and method for forming an alignment layer of an LCD device that substantially obviates one or more problems due to limitations and disadvantages of the related art.

An object of the present invention is to provide a device and method for forming an alignment layer of an LCD device, in which a drying part is vertically above a printing part, and an alignment layer is deposited on a substrate according to an ink-jet method, so that it is possible to form the alignment layer on the substrate without relation to the size of the substrate, and to improve the efficiency in using a clean room.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a device for forming an alignment layer of an LCD device includes a printing part for printing an alignment layer on a substrate; a drying part above the printing part for drying the alignment layer printed on the substrate; and a transferring part for transferring the substrate.

At this time, the device further includes at least one inkjet head for spraying an alignment material onto the substrate positioned between the printing part and the drying part.

Also, the plurality of inkjet heads are positioned in one line according to a long side or a short side of the substrate to print the alignment layer onto the long or short side of the substrate at one time.

The size and arrangement of the inkjet heads are varied according to the size and kind of the substrate.

The printing part includes a print table for receiving the substrate, and the inkjet head sprays an alignment material onto the substrate at a fixed state, so that the print table is moved at a horizontal direction.

The printing part includes a print table for receiving the substrate at a fixed state, and the inkjet head is moved on the substrate at a horizontal direction to spray an alignment material onto the substrate.

The alignment material sprayed from the inkjet head is polyimide PI.

The drying part includes a dry table for drying the alignment layer printed on the substrate by emitting heat.

The dry table includes a hot plate emitting heat in itself.

The transferring part includes a transfer robot for transferring the substrate from the printing part to the drying part by elevating.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flow chart illustrating a method for forming a general alignment layer;

FIG. 2 is a schematic view illustrating a device for forming an alignment layer of an LCD device according to a related art;

FIG. 3 is a plan view illustrating the inside of a general clean room having a device for forming an alignment layer in a roller method;

FIG. 4 is a schematic view illustrating a device for printing an alignment layer of an LCD device according to a preferred embodiment of the present invention;

FIG. 5 is a lateral view illustrating the device of FIG. 4 according to an embodiment of the present invention; and

FIG. 6 is a plan view illustrating an example of an inkjet head usable in the device for printing an alignment layer of an LCD device according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

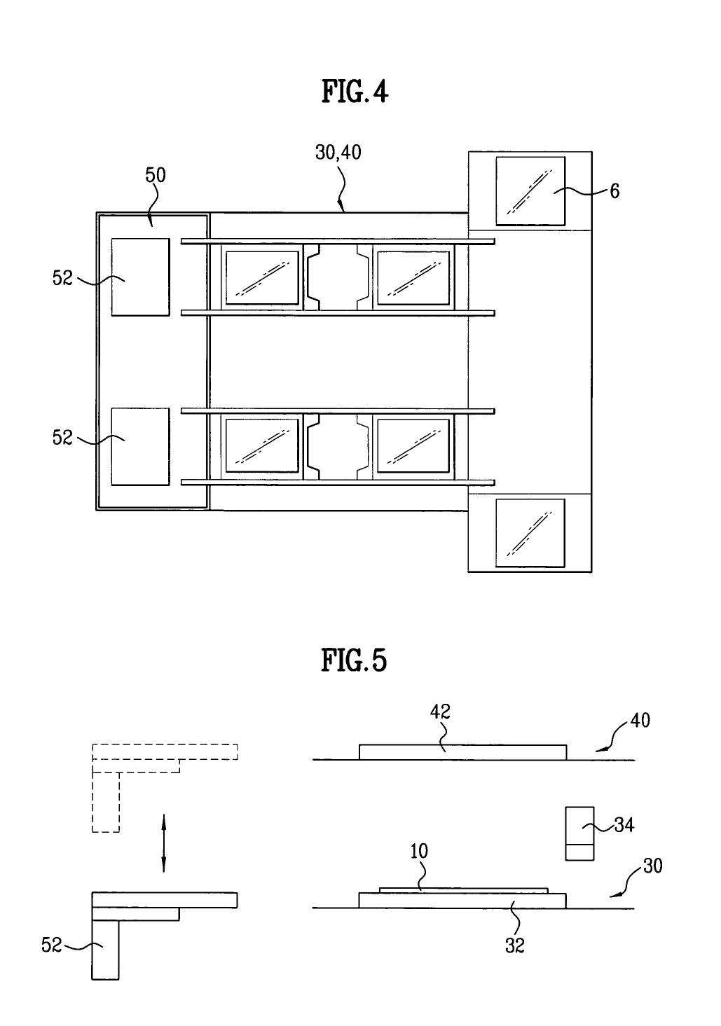

Hereinafter, a device and method for printing an alignment layer of an LCD device according to the present invention will be described with reference to the accompanying drawings. FIG. 4 is a schematic view illustrating a device for printing an alignment layer of an LCD device according to a preferred embodiment of the present invention. Particularly, FIG. 4 is a top view illustrating an example of a clean room having a device for printing an alignment layer of an LCD device according to an embodiment of the present invention. FIG. 5 is a lateral view illustrating the device of FIG. 4 according to an embodiment of the present invention.

As shown in FIG. 4 and FIG. 5, the device for printing the alignment layer of the LCD device according to the present invention includes a transferring part 6, a printing part 30 for printing an alignment layer, a drying part 40 for drying a substrate 10 on which the alignment layer is printed, and a transferring part 50 having a transfer robot to transfer the dried substrate 10. All the components of the device are operatively coupled.

The printing part 30 has one or more print tables 32 each for receiving the substrate 10 or the like, and the drying part 40 includes one or more dry tables 42. The print table 32 is located vertically below the dry table 42. In one example, the dry table 42 is positioned vertically and directly above the print table 32. In another example, the dry table 42 is generally positioned above or higher than the print table 32, but may not need to be directly above it. Then, an inkjet head 34 (e.g., one head, a plurality of heads or at least one array of heads) is positioned between the print table 32 and the dry table 42.

In one embodiment, the inkjet head 34 in a fixed state sprays an alignment material 20 onto the substrate 10 while the print table 32 is horizontally and/or vertically moved to cover the alignment material 20 all over the substrate 10 or as needed. In another embodiment, the print table 32 is in a fixed state while the inkjet head 34 horizontally and/or vertically moving on the substrate 10 sprays the alignment material 20 onto the substrate 10. In other variations, both the inkjet head 34 and the print table 32 may be moved to spray the alignment material 20 onto the substrate 10. Preferably, an alignment layer 21 is formed of the alignment material 20 such as polyimide PI, but other materials may be used.

The dry table 42 may emit heat in itself, or have an additional hot plate for drying the substrate 10. The dry table 42 (hereinafter referred to as ‘hot plate’) emits the heat variable according to a size and/or a thickness of the substrate 10. Generally, in one example, the dry table 42 emits the heat of about 60° C. to 80° C. for one minute or less. Other examples are possible.

Specifically, the print table 32 may be horizontally (and/or vertically) moved according to a pinion gear structure, a rack gear structure or using known moving schemes. However, in the device according to the present invention, it is also possible to maintain the print table 32 at the fixed state. In this case, the inkjet head 34 is horizontally (and/or vertically) moved to spray the alignment material 20 onto the entire or desired surface of the substrate 10, while the print table 32 is not moved.

As a result of spraying the alignment material 20 onto the substrate 10, the alignment layer 21 is printed on the substrate 10. After completing the printing of the alignment layer 21 by spraying the alignment material 20 through the inkjet head 34, a drying process is performed to the substrate 10 for drying a solvent in the alignment layer 21 before a baking process. The drying process may be performed in an infrared ray (IR) heat chamber. However, in the preferred embodiment of the present invention, the hot plate 42 occupying a small space and having great drying efficiency is provided to perform the drying process. That is, after completing the printing process on the substrate 10, the transfer robot 52 lifting the substrate 10 with an arm is elevated to move and place the printed substrate 10 on the hot plate 42 as shown in FIG. 5. Accordingly, the alignment layer 21 of the substrate 10 is dried on the hot plate 42 that is preheated at a predetermined temperature. Next, the substrate 10 is transferred for the baking process and the rubbing process. The baking and rubbing processes may be performed using conventional baking and rubbing techniques.

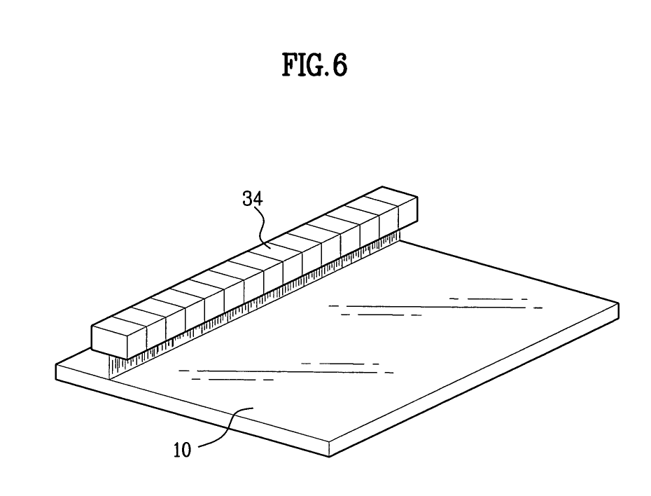

FIG. 6 is a plan view illustrating an example of an inkjet head usable in the device (e.g., as shown in FIG. 4) for printing an alignment layer of an LCD device according to one embodiment of the present invention. In one embodiment, in the device for printing the alignment layer of the LCD device, a single inkjet head may be moved on the entire surface of the substrate 10 to spray the alignment material thereon. But, preferably, the plurality of inkjet heads (an array of inkjet heads) are arranged in at least one line according to a long side or a short side of the substrate 10 to spray the alignment material on the substrate 10 like scanning. At this time, the number and/or arrangement of the inkjet heads 34 may be varied according to the kind and/or size of the substrate 10. For example, multiple arrays of inkjet heads may be used to move quickly and spray on the entire surface of a large substrate. Also, it is possible to horizontally move at least one of the inkjet head 34 and the print table 32 receiving the substrate 10, thereby depositing the alignment layer on the substrate 10. In case of using one inkjet head, it is preferable to move both the inkjet head and the substrate.

In the present invention, the substrate may be a glass substrate (first/second substrate of an LCD) or any other substrate in need of an alignment layer. In this regard, the present device and method are equally applicable to forming an alignment layer or other type of layer on a base layer for other types of display devices or for non-display devices. In the device and method for printing the alignment layer of the LCD device according to the present invention, the drying part 40 is positioned vertically above the printing part 30 for printing the alignment layer 21, thereby improving greatly the efficiency in using the internal space of the clean room.

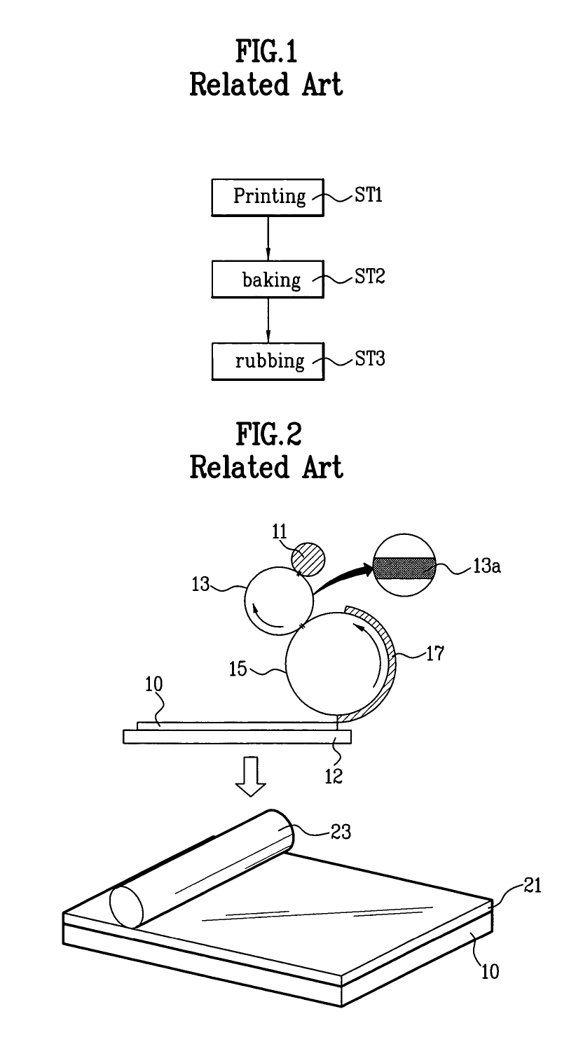

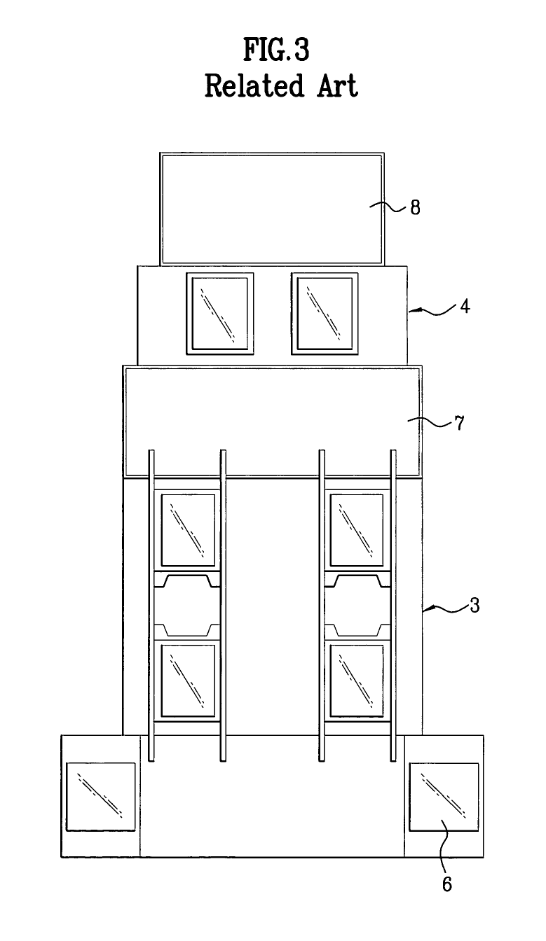

In case a related art roller method of FIGS. 1 and 2, the height of the roller(s) is positioned at 2.5 m to 3 m, and the substrate 10 passes through the transferring parts for the printing/drying process, whereby the size of the device for forming the alignment layer according to the related art becomes large. However, in the device and method according to the present invention, the drying part is positioned vertically or substantially vertically above the printing part for printing the alignment layer 21, so that it is possible to decrease the space of the drying part and the transferring part, thereby improving the efficiency in using the internal space of the clean room.

As mentioned above, the device and method for printing the alignment layer of the LCD device according to the present invention have at least the following advantages.

In the device and method for printing the alignment layer of the LCD device according to the present invention, the alignment layer is printed in the inkjet method. Accordingly, even though the size of the substrate becomes large, the alignment layer can be easily and quickly printed on the substrate.

Also, because of the arrangement of the printing part and the drying part, it is possible to decrease the height of the device for printing the alignment layer of the LCD device according to the present invention. Thus, immediately upon completing the printing process, the drying process is performed in the device for printing the alignment layer of the LCD device according to the present invention, thereby improving greatly the efficiency in using the internal space of the clean room.

Moreover, the use of the inkjet method for spraying the alignment material simplifies the alignment layer printing system by eliminating the use of rollers needed in the related art.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A device usable for forming an alignment layer of a display apparatus, the device comprising:
a printing part to print an alignment layer on a substrate;
a drying part positioned above the printing part to dry the alignment layer printed on the substrate; and
a transferring part to transfer the substrate.

2. The device of claim 1, further comprising:
at least one inkjet head to spray an alignment material onto the substrate and thereby print the alignment layer and being positioned between the printing part and the drying part.

3. The device of claim 2, wherein at least one array of inkjet heads is positioned in one line according to a long side or a short side of the substrate to print the alignment layer onto the long or short side of the substrate at one time.

4. The device of claim 3, wherein a size and an arrangement of the inkjet heads are varied according to a size and a kind of the substrate.

5. The device of claim 2, wherein the printing part includes a print table to receive the substrate, and the inkjet head sprays the alignment material onto the substrate at a fixed state while the print table is moved in a horizontal direction.

6. The device of claim 2, wherein the printing part includes a print table to receive the substrate at a fixed state, and the inkjet head is moved over the substrate in a horizontal direction to spray the alignment material onto the substrate.

7. The device of claim 2, wherein the alignment material sprayed from the ink-jet head is polyimide PI.

8. The device of claim 1, wherein the drying part includes a dry table to dry the alignment layer printed on the substrate by emitting heat.

9. The device of claim 8, wherein the dry table includes a hot plate emitting heat.

10. The device of claim 1, wherein the transferring part includes a transfer robot to transfer the substrate from the printing part to the drying part by elevating the substrate.

11. The device of claim 1, wherein the alignment layer is an alignment layer provided in a liquid crystal display device.

12. The device of claim 1, wherein the printing part, the drying part and the transferring part are provided in a clean room.

13. The device of claim 1, wherein the drying part is positioned directly and vertically above the printing part.

14. A device usable for forming an alignment layer of a display apparatus, the device comprising:
first means for printing an alignment layer on a substrate;
second means, positioned above the first means, for drying the alignment layer printed on the substrate; and
third means for transferring the substrate.

15. A method usable for forming an alignment layer of a display apparatus, the method comprising:
printing, by a printing part, an alignment layer on a substrate;
drying, by a drying part positioned above the printing part, the alignment layer printed on the substrate; and
transferring the substrate.

16. The method of claim 15, wherein the printing step includes:
spraying, by at least one inkjet head, an alignment material onto the substrate, the inkjet head being positioned between the printing part and the drying part.

17. The method of claim 16, wherein in the printing step, at least one array of ink-jet heads is positioned in one line according to a long side or a short side of the substrate to print the alignment layer onto the long or short side of the substrate at one time.

18. The method of claim 17, wherein in the printing step, a size and an arrangement of the inkjet heads are varied according to a size and a kind of the substrate.

19. The method of claim 16, wherein the printing part includes a print table to receive the substrate, and in the printing step, the inkjet head sprays the alignment material onto the substrate at a fixed state while the print table is moved in a horizontal direction.

20. The method of claim 16, wherein the printing part includes a print table to receive the substrate at a fixed state, and in the printing step, the inkjet head is moved over the substrate in a horizontal direction to spray the alignment material onto the substrate.

21. The method of claim 16, wherein in the spraying step, the alignment material sprayed from the inkjet head is polyimide PI.

22. The method of claim 15, wherein in the printing step, the alignment layer is an alignment layer provided in a liquid crystal display device.
